(19) United States
(12) Patent Application Publication
(10) Pub. No.: US 2021/0172529 A1
(43) Pub. Date: Jun. 10, 2021

(54) FLOATING RING SEAL

(71) Applicant: EagleBurgmann Germany GmbH & Co. KG, Wolfratshausen (DE)

(72) Inventor: Robert Imhauser, Koln (DE)

(73) Assignee: EagleBurgmann Germany GmbH & Co. KG, Wolfratshausen (DE)

(21) Appl. No.: 17/048,277

(22) PCT Filed: Mar. 25, 2019
(86) PCT No.: PCT/EP2019/057438

§ 371 Date: Oct. 16, 2020

(30) Foreign Application Priority Data
Apr. 19, 2018 (DE) 10 2018 205 960.8

(51) Int. Cl. F16J 15/44

(52) U.S. Cl. CPC F16J 15/441

(57) ABSTRACT

The invention relates to a floating ring seal for sealing on a rotating component, comprising a one-piece body (20) including a first throttling surface (21) directed radially inward, a second throttling surface (22) directed radially inward, and a first circumferential groove (23) on the inner circumference of the one-piece body (20), the first groove (23) being located between the first throttling area (21) and the second throttling area (22) in the axial direction (X-X) of the floating ring seal.

The invention relates to a floating ring seal for sealing on a rotating component, especially a rotating shaft, having significantly reduced weight and simplified design.

Floating ring seals are known from prior art in various configurations. For example, floating ring seals are used to seal pump shafts in high speed pumps. The floating ring seals are in a floating arrangement on the shaft, allowing them to follow an appropriate radial deflection especially in the case of the shaft's radial deflection. An issue with floating ring seals is the permanent gap between the floating ring seal and the rotating component, where relatively strong leakage occurs. For this reason, several floating ring seals are usually arranged in series. However, this results in considerable constructional effort and, in particular, large installation space required in the axial direction of the component to be sealed, which increases the total installation length of the pump or the like, something that such pump manufacturers want to avoid as far as possible.

It is therefore the object of the invention to provide a floating ring seal for sealing on a rotating component, which floating ring seal is able to especially reduce any axial overall length of the seal with a simple and inexpensive design. Furthermore, it is the object of the present invention to provide a component arrangement including a floating ring seal according to the invention.

This object will be solved by a floating ring seal having the features of claim 1 and a component arrangement having the features of claim 9. The respective subclaims show preferred embodiments of the invention.

In addition to easier assembly/disassembly, the floating ring seal according to the invention for sealing on a rotating component provides significant weight advantage. According to the invention, the floating ring seal comprises a one-piece body including a first and a second throttling area directed radially inward. The throttling areas are separated from each other by a first circumferential groove on the inner circumference of the body. The groove is located between the first and second throttling area. The design of a one-piece floating ring seal comprising two throttling areas, wherein each of which is directed towards the rotating component, and having a throttling gap between the rotating component and the two throttling areas, results in significant weight advantage as compared to two individual prior art floating ring seals. In comparison to two individual floating ring seals, the total mass of the floating ring seal according to the invention can be reduced by approx. 40%.

Preferably, a width of the first throttling area in the axial direction of the floating ring seal is smaller or equal to a second width of the throttling area in the axial direction of the floating ring seal. This increases the throttling effect of the second throttling area, reducing overall leakage of the floating ring seal.

Another great advantage of the arrangement according to the invention having two throttling areas with a groove arranged in between resides in that a leakage flow, which flows across the first throttling area towards the second throttling area, is slowed down in the groove, so that the leakage will subsequently be significantly reduced across the second throttling area. Herein, the leakage flow can especially provide a counter flow.

Especially preferred is a groove width which is smaller than or equal to the first width of the first throttling area and/or which is smaller than or equal to the second width of the second throttling area.

According to another preferred embodiment of the invention, the one-piece body further comprises a third throttling area directed radially inward. The third throttling area is arranged in series to the second throttling area. Furthermore, a second circumferential groove is arranged between the second and third throttling areas on an inner circumference of the body.

The one-piece body preferably includes a fourth throttling area. A third circumferential groove is formed between the third and fourth throttling area on the inner circumference of the one-piece body. Thus, such a floating ring seal comprises four throttling areas and three circumferential grooves.

A carbon floating-ring seal is particularly preferred. Due to the one-piece design of the floating ring seal, significant cost reduction during manufacture can also be achieved, especially as a carbon floating ring seal.

According to another preferred embodiment of the invention, the floating ring seal furthermore comprises a seal ring carrier. The seal ring carrier is a separate component, holding the one-piece floating ring seal. The seal ring carrier preferably is arranged on a side of the one-piece body opposite to the throttling areas.

Preferably, the floating ring seal also comprises a housing, especially a titanium housing, including a recess for loosely retaining the one-piece body or the one-piece body with the seal ring carrier.

Furthermore, the present invention relates to a component arrangement comprising a floating ring seal according to the invention as well as a rotating component, especially a shaft. Especially preferably, the shaft is a pump shaft or a compressor shaft.

The component arrangement comprises a first throttling gap between the first throttling area of the one-piece body of the floating ring seal and the rotating component as well as a second throttling gap between the second throttling area of the one-piece body and the rotating component. Further preferably, the throttling areas and the surface of the rotating component are designed such that a gap height of the first throttling gap and/or the second throttling gap remains constant in axial direction. Preferably, a gap height of the first throttling gap is the same as a gap height of the second throttling gap.

Preferably, the component arrangement is a pump or a compressor or a turbine. The component arrangement is preferably operated at very high speeds.

In the following, preferred example embodiments of component arrangements comprising floating ring seals are described in detail, while reference will be made to the accompanying drawing, wherein:

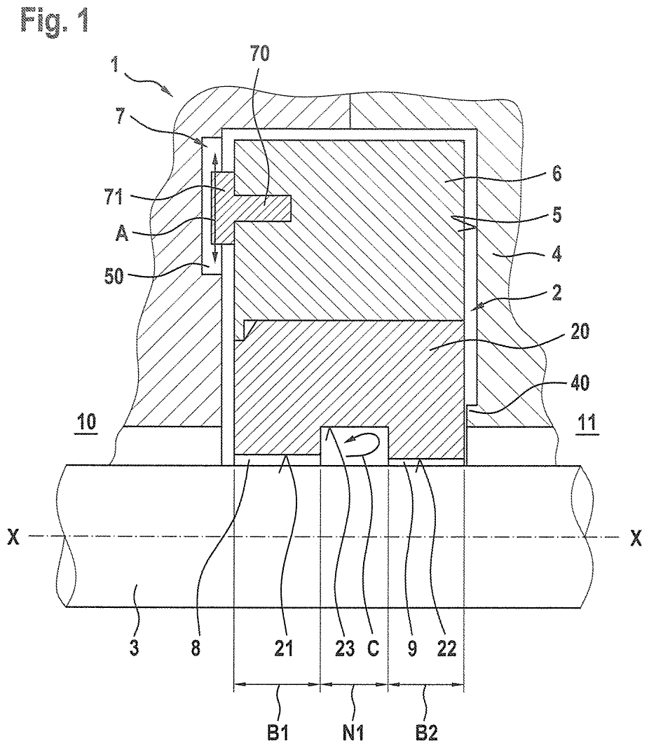

FIG. 1 is a schematic sectional view of a component arrangement comprising a floating ring seal, according to a first example embodiment of the invention,

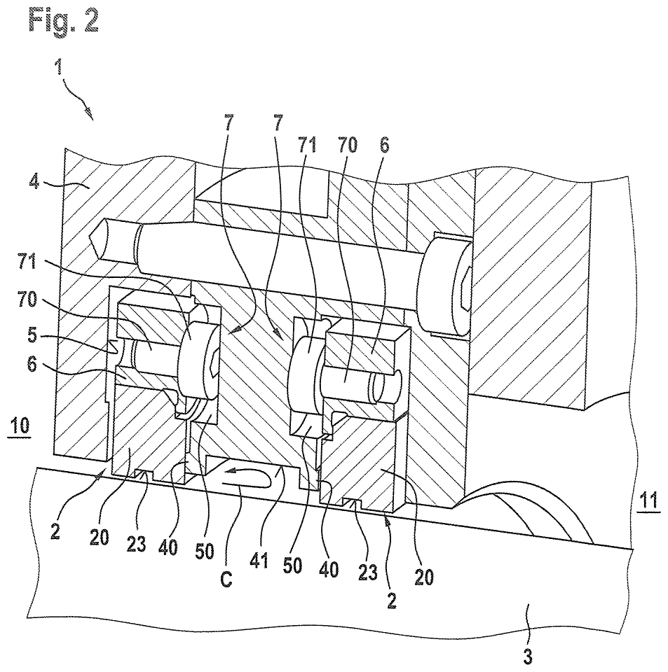

FIG. 2 is a schematic, perspective view of a component arrangement comprising a floating ring seal, according to a second example embodiment of the invention, and

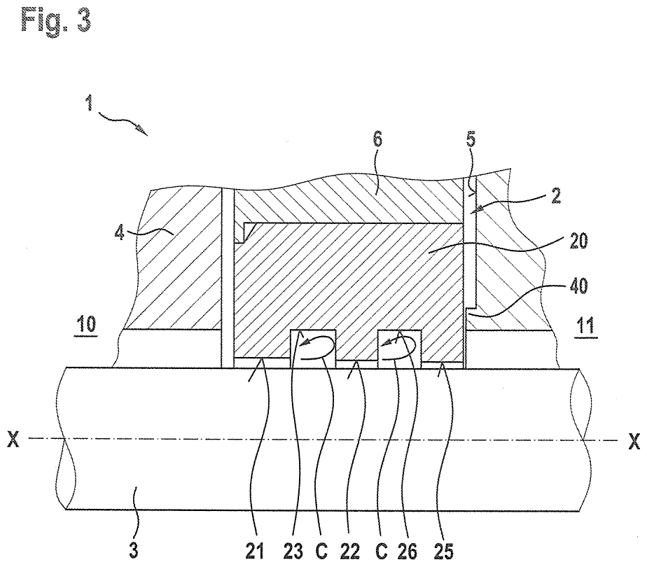

FIG. 3 is a schematic, perspective view of a component arrangement comprising a floating ring seal according to a third example embodiment of the invention.

Referring now to FIG. 1, a component arrangement 1 comprising a floating ring seal 2 will be described in detail below, according to a first example embodiment of the invention.

As can be seen from FIG. 1, the floating ring seal 2 comprises a one-piece body 20 and a seal ring carrier 6. The seal ring carrier 6 is adapted to retain the one-piece body 20.

The one-piece body 20 comprises a first throttling area 21 and a second throttling area 22. The first throttling area 21 is located at a radially inward directed region of the one-piece body 20. The second throttling area 22 is also located on the radially inward directed region of the one-piece body 20.

As can be seen from FIG. 1, the floating ring seal 2 seals a product region 10 from an atmosphere region 11 on a shaft 3. A first throttling gap 8 is formed between the first throttling area 21 and a surface of the shaft 3, and a second throttling gap 9 is formed between the second throttling area 22 and the surface of the shaft 3.

A groove 23 is arranged between the first throttling area 21 and the second throttling area 22 in the axial direction X-X of the floating ring seal 2. The groove 23 is formed throughout around the inner circumference of the one-piece body 20.

A first width B1 of the first throttling area 21 in axial direction X-X is smaller than a second width B2 of the second throttling area 22. Furthermore, a width N1 of the groove 23 in axial direction X-X is smaller than the first width B1 and the second width B2.

A first gap height at the first throttling gap 8 remains constant in axial direction X-X. A second gap height at the second throttling gap 9 in axial direction is also constant. The gap heights of the first and second throttling gaps are preferably selected such that the second gap height at the second throttling gap 9 is the same as the first gap height at the first throttling gap 8.

The floating ring seal 2 is located in a recess 5 in a housing 4. The housing 4 has a multiple part design to allow assembly in the axial direction of the shaft 3. As can be seen from FIG. 1, the floating ring seal 2 is arranged in recess 5 in a floating manner. This enables the floating ring seal 2 to follow the shaft movement in case of radial deflections of the shaft 3, which may occur during operation. In this case, the radial shaft movement may cause a short contact between the shaft 3 and the one-piece body 20.

The floating ring seal 2 also includes a locking mechanism 7 to allow it to be mounted in the body 4. The locking mechanism 7 comprises a bolt 70 with a head 71. As can be seen from FIG. 1, the bolt 70 is located in the seal ring carrier 6. The head 71 protrudes in axial direction X-X and is located in a lateral notch 50 in the recess 5. In the lateral notch 50, a radial clearance is provided for the head 71 such that the floating ring seal 2 is enabled to follow the radial deflections of the shaft described above. This is indicated by the double arrow A.

In order to enable the floating ring seal 2 to accommodate the radial deflections described above, a projection 40 is formed on the housing 4, projecting in axial direction X-X. This allows safe guiding of the floating ring seal in recess 5. The projection 40 also prevents the medium from circumventing the throttling gaps 8, 9 through a path behind the floating ring seal 2.

The projection 40 is provided so as to be completely circumferential in circumferential direction.

Thus, the two individual floating ring seals previously used in prior art technology can be replaced by the floating ring seal 2. In particular, significant weight reduction of up to approx. 40% can be achieved. Furthermore, the one-piece design of the floating ring seal 2 allows much easier assembly and disassembly if the floating ring seal 2 is required to be replaced. As the locking mechanism 7 is still provided exclusively in the seal carrier 6, the one-piece body 20 of the floating ring seal can be designed without incorporating weakening recesses, grooves or the like to accommodate a locking mechanism. This further reduces the weight of the body 20 and significantly extends service life of the one-piece body 20.

During operation, some leakage occurs through the first throttling gap 8, but the provision of the circumferential groove 23 significantly slows down the leakage flow velocity in the region of the groove 23. Thus, another leakage through the second throttling gap 9 towards the atmosphere region 11 is again significantly reduced or can be completely avoided if necessary.

The depth of the groove 23 is selected such that in the region of the groove 23 at least partial return flow C of the leakage, which has reached the groove 23 through the first throttling gap 8, occurs. This in addition reduces flow velocity of the leakage through the floating ring seal and minimizes further leakage through the second throttling gap 9.

FIG. 2 shows a component arrangement 1 according to a second embodiment of the invention, wherein equal or operationally equal parts are designated by the same reference numbers.

As can be seen from FIG. 2, the component arrangement 1 comprises two separate floating ring seals 2 according to the invention. The basic structure of the floating ring seals 2 is the same as in the first example embodiment. However, as can be seen from FIG. 2, the floating ring seals 2 are arranged mirror-inverted to each other on the shaft 3. Thus, a total of four throttling gaps are provided in the direction from the product region 10 to the atmosphere region 11. Furthermore, as can be seen from FIG. 2, a circumferential groove 41 is provided in the housing 4 in the region between the first and second floating ring seals 2. In this circumferential groove 41, the leakage supplied through the first floating ring seal 2 accumulates and forms a return flow C and further reduces the leakage occurring through the second floating ring seal to the atmosphere region 11.

FIG. 3 shows a component arrangement according to a third example embodiment of the invention. As can be seen from FIG. 3, the floating ring seal 2 of the third example embodiment comprises a third throttling area 25, including a first groove 23 provided between the first and second throttling areas 21, 22 and a second groove 26 provided between the second throttling area 22 and the third throttling area 25. As in the first example embodiment, the first groove 23 and the second groove 26 are designed to be completely circumferential. This provides a one-piece body 20 comprising three throttling areas, thus further reducing leakage from the product region 10 to the atmosphere region 11.

### LIST OF REFERENCE NUMBERS

1 component arrangement
2 floating ring seal
3 shaft
4 housing
5 recess
6 sealing ring carrier
7 locking mechanism
8 first throttling gap
9 second throttling gap
10 product region
11 atmosphere region
20 one-piece body
21 first throttling area
22 second throttling area
23 first groove
24 projection
25 third throttling area
26 second groove
40 projection
41 groove
50 lateral notch
70 bolt
71 head
A double arrow
B1 first width
B2 second width
C return flow
N1 groove width of the first groove 23
X-X Axial direction

1. A floating ring seal for sealing on a rotating component, comprising:
a one-piece body including
a first throttling area directed radially inward,
a second throttling area directed radially inward, and
a first circumferential groove on the inner circumference of the one-piece body,
wherein the first groove is arranged between the first throttling area and the second throttling area in the axial direction of the floating ring seal.

2. The floating ring seal according to claim 1, wherein a first width of the first throttling area is smaller than or equal to a second width of the second throttling area.

3. The floating ring seal according to claim 2, wherein the first groove has a groove width which is smaller than or equal to the first width and which is smaller than or equal to the second width.

4. The floating ring seal according to claim 1, wherein the one-piece body further comprises a third throttling area directed radially inward wherein a second groove is located in the axial direction of the floating ring seal between the third throttling area and the second throttling area.

5. The floating ring seal according to claim 1, wherein the one-piece body is made of a material comprising carbon.

6. The floating ring seal according to claim 1, further comprising a seal ring carrier carrying the one-piece body.

7. The floating ring seal according to claim 6, wherein the seal ring carrier is located on a side of the one-piece body opposite the throttling areas.

8. The floating ring seal according to claim 1, further comprising a housing including a recess for receiving the one-piece body in a floating manner.

9. A component arrangement comprising at least one floating ring seal according to claim 1 and a rotating component.

10. The component arrangement according to claim 9, wherein a first gap height of a first throttle gap between the first throttling area and a surface of the rotating component remains constant and/or wherein a second gap height of a second throttle gap between the second throttling area and the surface of the rotating component remains constant.

11. The component arrangement according to claim 10, wherein the first gap height is the same as the second gap height.
